(19) United States
(12) Patent Application Publication
(10) Pub. No.: US 2015/0180878 A1
(43) Pub. Date: Jun. 25, 2015

(54) UNAUTHORIZED USER CLASSIFICATION

(71) Applicants: Alen Puzic, Austin, TX (US); Jasiel R. Spelman, Austin, TX (US); Jason L. Jones, Austin, TX (US); Michael D. Dausin, Austin, TX (US)

(72) Inventors: Alen Puzic, Austin, TX (US); Jasiel R. Spelman, Austin, TX (US); Jason L. Jones, Austin, TX (US); Michael D. Dausin, Austin, TX (US)

(21) Appl. No.: 14/418,927

(22) PCT Filed: Jul. 31, 2012
(86) PCT No.: PCT/US2012/048989

§ 371 Date: Jan. 30, 2015

(51) Int. Cl. H04L 29/06

(52) U.S. Cl. CPC H04L 63/102; H04L 63/101

(57) ABSTRACT

Systems, methods, and machine-readable and executable instructions are provided for unauthorized use classification. Unauthorized user classification can include assigning a user a number of life points, wherein the user is identified through an associated intemet protocol (P) address and associated browser header information. Unauthorized user classification can also include receiving a first request for a first set of data and a second request for a second set of data from the user. Unauthorized user classification can include adjusting the number of life points based an a relationship between the first request and the second request, wherein the relationship is a pattern including the first request and the second request that is used to determine whether the user is an automated user. Unauthorized user classification can include classifying the user as unauthorized when the number of life points fall below a point threshold.

### BACKGROUND

A website can make data available to a number of users. A number of users can receive data from the website through a number of requests. The website can determine to respond to the number of requests, in a manner that enhances the security of a website.

### BRIEF DESCRIPTION OF THE DRAWINGS

FIG. 1 is a flow chart illustrating an example of a method for detecting unauthorized users according, to the present disclosure.

FIG. 2 is a diagram illustrating an example of a trap path including comparing a number of time intervals between a number of requests according to the present disclosure.

FIG. 3 is a diagram illustrating an example of a trap path consisting of a number of consecutive links according to the present disclosure.

FIG. 4 is a diagram illustrating an example of a trap path consisting of a number of invisible links according to the present disclosure.

FIG. 5 illustrates an example computing device according to the present disclosure.

### DETAILED DESCRIPTION

A website can include a number of web pages that can be designed by a single entity, eg , a designer. A designer can include a single person and/or a number of people that constitute a design team. A website can contain data that is distributed between a number of web pages and/or a number of files located on a web server and/or a number of web servers that host the website. The data on a website can have a value and can be protected from a number of users.

As used herein, a user can include a human user and/or a non human, e.g., automated, user. An example of a non human user can include a set of machine readable instructions (MRI), e.g., a bot, that performs a number of tasks such as gathering, data from a website. A bot can include a crawler that performs the automated task of gathering data from a website. A crawler can gather data from a website by sending a number of requests that are associated with a number of links in a web page that can be associated with a website.

A number of users can be classified into authorized users and unauthorized users. An authorized user can include a user for whom the data in a website is intended for by a designer. An authorized user can include a user who returns value to a website. An unauthorized user can include a user for whom the data in a website was not intended for by the designer. An unauthorized user can also include a user who gathers data without returning a value to a website. Value can be returned to a website by contributing user data to the website, by participating in a website through visiting advertisers who advertise with the website, and/or through other means.

The data can be protected by designing a website to model a game. For example, the data can be protected by including a number of safe paths, e.g., a number of safe links, in a number of web pages. The data can further be protected by including a number of trap paths, e.g., a number of trap links, in a number of web pages.

A website can be modeled after a number of different types of games. A type of game can include a category of a gaming industry. For example, a type of game can include a first-person shooter, a role-play, and/or a life simulation, among other types of games.

Previous approaches to protecting data on a website include counting the requests from a user and/or the frequency of the requests to identify users that should not have access to the data on a website. However, users can employ a number of sleep cycles in between a number of requests and/or adjust the volume of requests to obtain data from a website. That is, previous approaches to protecting data on a website include weak solutions because the standards by which the requests are measured to determine if data should be released to a user are known.

In a number of examples of the present disclosure, a website that includes a number of web pages can be designed to model a game. For example, a website can be designed to include a number of levels wherein each level can give greater access to a set data as compared to lower levels. For example, a first level can grant a user access to a first subset of data, the first subset of data being included in a set of data. A second level can grant greater access to the set of data by granting the user access to the first subset of data and the second subset of data, the second subset of data being included in the set of data. A level can include a single web page and/or a number of web pages. A website design, as used herein, does not require a number of levels but can include other concepts of progression based on a gaming scenario.

A website can also be designed to include a number of paths that lead from a first level to a second level, the first level and the second level being part of a number of levels that can be included in a website. A number of paths can include a safe path and/or other paths that can grant privileges to a user. A number of safe paths can be expressed as a number of links in a website and/or as a number of patterns that can include a number of interaction that a user has with a website. Safe paths can be categorized as good behavior within a website that can be analogous to a game. Good behavior can include behavior that indicates that a user is a human user and not an automated user.

A number of paths can include a trap path and/or other paths that can deny privileges to a user. A trap path can be designed to capture unauthorized users through their behavior and/or inability to follow a number of safe paths. A number of trap paths can be expressed through a number of links in the website and/or a number of patterns that can be followed through the interactions that a user has with a website. Trap paths can be categorized as bad behavior within a website that can be analogous to a game.

A user can be granted a number of life points at a beginning of a user's interactions with a website. As a user progresses from level to level and/or through a number of paths, the user can be granted points and/or can loose points. Points can be granted when a user follows a number of safe paths. Points can be lost when a user follows a number of trap paths. By creating a number of paths, e.g., patterns, a user, for whom the data in a website was not intended, is unable to remain undetected because the user does not know the standard by which his requests are being judged. That is, a user does not know the topology, e.g., levels and/or paths, of the website analogous to not knowing the layout of a game before playing it.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

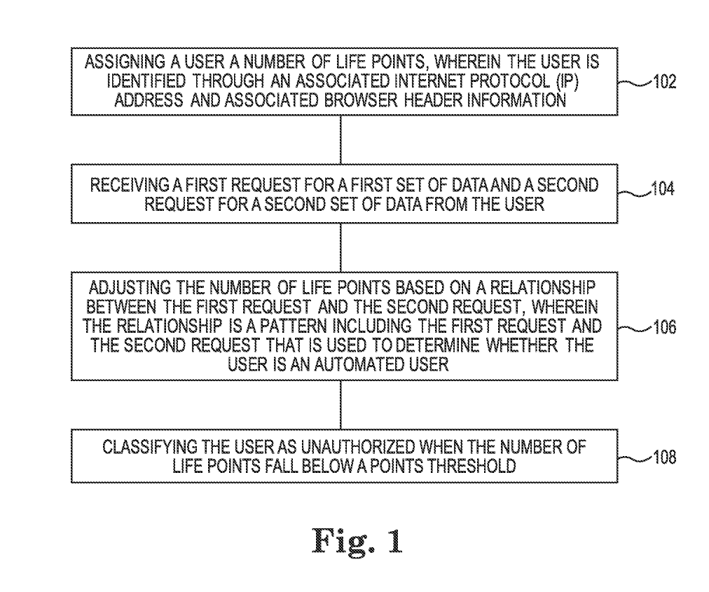

FIG. 1 is a flow chart illustrating an example of a method for detecting unauthorized users according to the present disclosure. At 102, a user can be assigned a number of life points. In a number of examples, a number of life points can define a number of privileges that a user can have. A number of privileges can include privileges that are associated with retrieving data from a website. Privileges can include a number of rewards that can be provided to a user. Rewards can include anything that makes the experience that a user has, while navigating a website, an enjoyable experience. For example, a privilege and/or a reward can include a priority in which a number of requests are answered such that requests with a high priority can answered before requests with a low priority. A privilege and/or reward can include the access that a user has to a set of data. For example, a user can be granted a privilege of accessing a set of data, wherein a user who does not have the privilege cannot access the set of data.

At 104, a first request from a user can be received for a first set of data and a second request can be received for a second set of data. As used herein, a request can include any interactions that a user has with a website. For example, a request can be a Hypertext Transfer Protocol (HTTP) request or any other type of protocol used in the transfer of data from a website to a user. A request can include an Internet protocol (IP) address from where the user sent a request. A request can also include header information. The header information can include browser identification, a browser version, and/or an operating system (OS) identification, among others. The browser information and a browser version can include information about a browser that a user is using to send a number of requests. An OS identification can identify an OS that the user is using to send a number of requests. The header information and/or the IP address can be used to uniquely identify a user. In a number of examples of the present disclosure, a user can be identified using unique identifier (e.g., cookie).

A request can include interactions between a user and a website which are solicited by a user and interactions which are not solicited by the user. For example, a request can include a request that is created when a user selects a link on a website. A request can include multimedia interaction that a user has with a website such that no data travels from the user to the website. For example, a script that a website sends to a user can run on a computer that belongs to a user without requiring a transfer of information from the user to the website.

Data can include any content that is transmitted to a user. Data can include a format or protocol that is used to transmit a reply to a request, e.g., HTTP request. Data can also include any information that a user can gather from a website. For example, data can include information regarding the operating system of a server on which the website is hosted.

At 106, a number of life points can be adjusted based on a relationship between the first request and the second request. In a number of examples of the present disclosure, a first request can be created when a user selects a first link and a second request can be created when the user selects a second link. A relationship between a first link and a second link can define the relationship between a first request and a second request. A first link and a second link can be related through a website. For example, the first link and the second link can be displayed in an instance of a web page that a website creates.

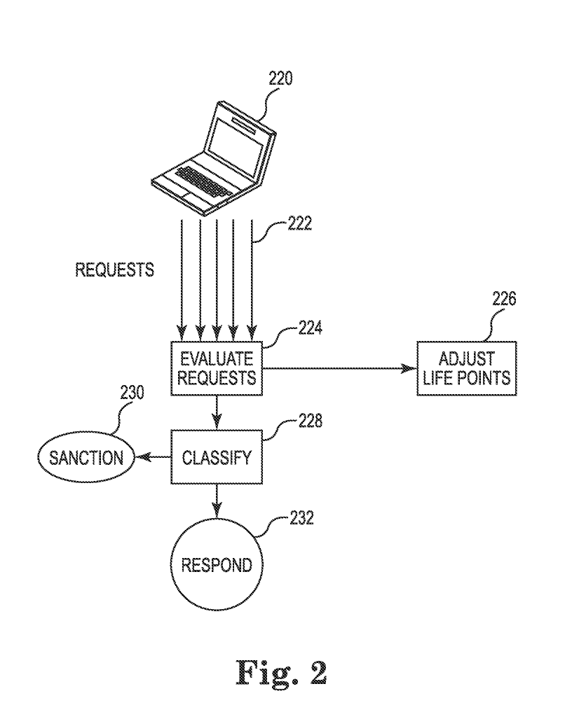

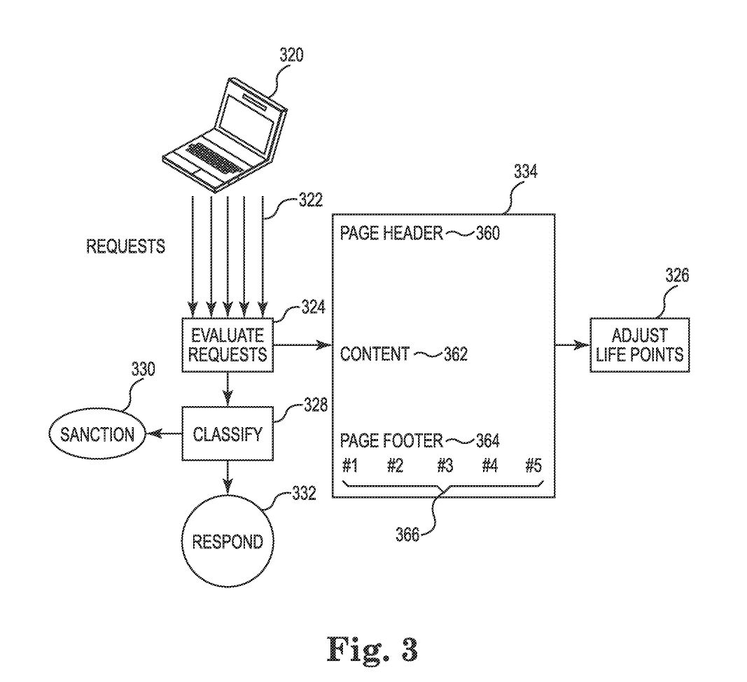

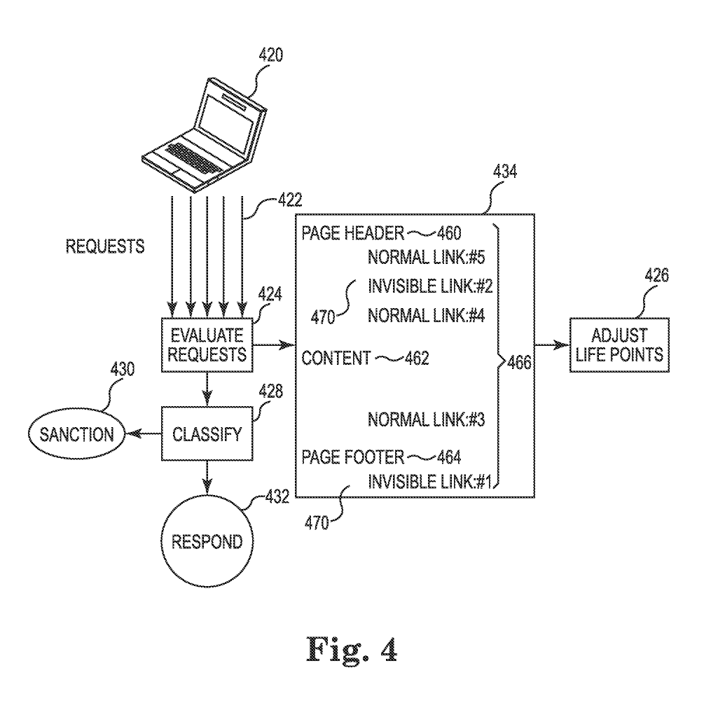

A first link and a second link can be related because they belong to a common path, e.g., safe path and/or trap path. For example, a first link can be a first link in a safe path and a second link can be a link that follows after the first link in the safe path. A first link can be a first link in a trap path and a second link can be a link that follows after the first link in the trap path. FIG. 2, FIG. 3, and FIG. 4 demonstrate examples of a number of trap paths among other examples of the number of trap paths.

A first link and a second link can be related through a web page and/or a number of web pages. For example, a safe path, e.g., a number of links, that spans a number of web pages can include a first link in a first web page and a second link in a second page. A relationship between a first link and a second link that spans a number of web pages can demonstrate that a user is progressing through a safe path.

A relationship between a first link and a second link can include moving from a safe path to a trap path. For example, a first link can be included in a safe path and a second link can be included in a trap path. The movement from a safe path to a trap path, by a user, can demonstrate a progression in a trap path.

Adjusting life points can include evaluating the relationship between a first link and a second link as a means of determining the relationship between a first request and a second request. A user can be rewarded by adding a number of points to the life points that belong to a user, in examples in which the relationship between a first link and a second link demonstrates progression in a safe path. Furthermore, a placement of a first link and a second link within a safe path can influence the number of points that a user is granted. For example, a user that has followed a number of links in a safe path can be awarded more points than a user that has followed a single link in a safe path. In a number of examples of the present disclosure, a safe path and a trap path can include an end safe link and an end trap link, respectively. An end safe link can identify an end of the safe path. An end trap link can identify an end of the trap path.

A progression of a user and/or an HTTP request can include a progression on a trap path and/or a progression on a safe path. A progression can be determined by determining a placement of a link on a safe path and/or a trap path, wherein the link can include a link that generated an HTTP request. For example, a safe path and/or a trap path can include a first link, a second link, and a third link. If a third link generated an HTTP request that is being evaluated, then a user and/or the HTTP request can be at the end of a safe path and/or at the end of a trap path. Reaching the end of a safe path can indicate that a user is ready for greater access to a set of data. Reaching the end of a trap path can indicate that the access that a user has to a set of data can be restricted.

Points can also be removed from the life points that belong to a user, in examples in which the relationship between a first link and a second link demonstrates progression in a trap path. In a number of examples of the present disclosure, a trap path can include a link and/or a plurality of links that are designed to distinguish an authorized user from a unauthorized user.

The relationship between a number of requests can be expressed as a pattern. A path can include links and other factors that are associated with a request. For example, a time interval between a number of requests can constitute a pattern and can be part of a path.

A website can include a number of levels. As a user progresses through a number of levels a user can gain access to a greater set of data than if the user did not progress through the number of levels. Each level, analogous to levels in a game, can be associated with a number of safe paths and/or a number of trap paths. For example, if a user is located at a third level and a user follows a trap path the user can loose life points such that the user looses a level and is returned to a second level. A level can consist of a single web page and/or a number of web pages. A safe path can direct a user from a first level to a second level. A safe path can direct a user from any level to any other level including a lower level. In cases in which a safe path directs a user from, for example, a fifth level to a second level, a user can retain accumulated life points.

Progression through a number of levels, e.g., different portions of a website, can include a number of user tasks other than following links. For example, a user can be required to disclose user data to gain admittance to a level. Disclosing user data can include a set of data that a website does not have and that the user possesses. For example, a user can disclose a user data to a website by providing content to a website. Disclosure of user data can include user data that a website possesses but that is not made available to the public, e.g., all users that can access the website. For example, a secret password can be user data.

A user can progress through a number of levels, e.g., different portions of a website, by completing a number of tasks that can be external to the website. A task that is external to a website can include, for example, visiting an advertisement website.

Life points can be evaluated at different junctions. For example, life points can be evaluated every time a request is received by a website from a user. Life points can be evaluated at a number of intervals. For example, life points can be evaluated after every fifth request, among other request intervals.

At 108, a user can be classified as unauthorized when a number of life points fall below a point threshold. A point threshold can include a minimum number of points that a user must maintain use the website analogous to participating in a game. A point threshold can include a minimum number of points that a user must maintain before a user is sanctioned. Sanctions can include any change to the interaction a user has with a website such that the experience is diminished compared to an experience that does not feature sanctions. A sanction can limit the ability that a user has to gather data from a website.

For example, a first sanction can be applied when a number of life points fall below a first point threshold and a second sanction can be applied when a number of life points fall below a second point threshold. In a number of examples of the present disclosure, the severity of a sanction can depend on how far a number of life points fall below a point threshold. For example, a sanction can include delaying a response to a request, the delay can be proportional to how far a number of life points fall below a point threshold. Another example can include denying a response to a request.

FIG. 2 is a diagram illustrating an example of a trap path including comparing a number of time intervals between a number of requests according to the present disclosure. A user 220 can send a number of requests 222 to a website. A number of requests can be collected over a time interval. A time interval can begin with a first time stamp that is associated with a first request and can end with a last time stamp that is associated with a last request from a number of requests.

A number of requests can be evaluated multiple times as a user progresses through a path. For example, a first number of requests can be evaluated at a first time and/or at a first place in a trap path. A second number of requests can be added to the first number of request to create a third number of requests. The third number of requests can be evaluated at a second time and/or at a second place in a trap path.

A number of requests can be evaluated 224 to determine whether a user is progressing on a path. For example, an evaluation of a number of requests can determine if the number of requests follow a pattern that is atypical of an interaction that a human user might normally have with a website. A pattern can include a rate at which a number of events are received. For example, as used in FIG. 2, a trap path can include a pattern that includes receiving one or more requests per second. In a number of examples of the present disclosure, a pattern can include receiving a number of requests that is greater than a request threshold, among other patterns. For example, a trap path can include a pattern that includes receiving more than two hundred requests from a user within one visit to a website. A pattern is not limited to any time interval and/or any number of requests received from a user. As used in FIG. 2, a safe path can include a pattern that includes receiving less than one request per second.

A number of life points, that are assigned to a user, can be adjusted 226. A number of life points can be adjusted 226 depending on whether a user is progressing through a safe path and/or a trap path. For example, a number of requests 222 can include twenty requests and the twenty requests can be received over a time interval of twenty seconds, the twenty requests can have been received at a rate of one request per second. The rate of one request per second can place a user in a trap path.

Once a user is identified as progressing in a trap path, the life points that are assigned to a user can be adjusted 226. For example, a number of points can be removed from a number of life points that are assigned to a user.

In a number of examples of the present disclosure, a user can be identified as progressing in a safe path and a number of life points can be adjusted 226 accordingly. For example, a number of points can be added to the number of life points assigned to a user.

At 228, a user can be classified as unauthorized and/or authorized depending on a number of life points. A user can be classified as unauthorized when a number life points assigned to the user fall below a point threshold. A user can be classified as authorized when a number of life points assigned to a user are greater than a point threshold. A point threshold can include a number of thresholds. A number of point thresholds can further classify a user into a number of classifications beyond authorized and unauthorized.

A number of point thresholds can determine the number of sanctions 230 that can be applied to a user. For example, a user that is classified as unauthorized can be sanctioned by delaying a response to a last request from a number of requests 222. A sanction can limit the interactions that a user has with a website. A sanction can limit the access that a user has to data within a website.

A user that is classified as authorized can be rewarded by receiving a response to the last request from a number of requests 222. A user can further be rewarded by continuing in a safe path towards a next level, e.g., access to more data.

FIG. 3 is a diagram illustrating an example of a trap path consisting of a number of consecutive links according to the present disclosure. A number of requests 322, analogous to a number of requests 222 in FIG. 2, from a user 320, analogous to a user 220 in FIG. 2, can be evaluated 324. In FIG. 3, a trap path can include a number of links 366 in a web page 334 that can be created by a website, wherein the number of links can include a number of consecutive links. A number of consecutive links can be located in any section of a web page 334. For example, a number of links 366 can be located in a page header section 360, a content section 362, and/or a page footer section 364, among other locations. In FIG. 3, a number of links 366 can be located in a page footer section 364.

A number of requests 322 can be evaluated to determine if a first link from a number of consecutive links generated a first request from the number of requests 322, a second link from the number of consecutive links generated a second request from the number of requests 322, a third link from the number of consecutive links generated a third request from the number of requests 322, a fourth link from the number of consecutive links generated a fourth request from the number of requests 322, and a fifth link from the number of consecutive links generated a fifth request from the number of requests 322. A number of consecutive links can be selected as a trap path because a human user does not regularly follow links in a consecutive manner. That is, a user that follows a number of consecutive links demonstrated behavior consistent with a bot, e.g., automated user.

Each of a number of consecutive links in a web page 334 can be a step in a trap path and/or the number of consecutive links collectively in a web page 334 can be a step in a trap path. A number of life points assigned to a user can be adjusted 326. For example, a user can loose point from a number of life points assigned to the user if a number of requests 322 correspond to a number of consecutive links. In a number of examples of the present disclosure, a user can gain no life points or can gain a number of points if a number of requests 322 do not correspond to a number of consecutive links.

A user can be classified 328 as authorized and/or as unauthorized. A sanction 330 can be applied if a user is classified 328 as unauthorized. A response 332 can be sent to a user 320 if a user is classified 328 as authorized.

FIG. 4 is a diagram illustrating an example of a trap path consisting of a number of invisible links according to the present disclosure. In FIG. 4, a user 420, analogous to a user 220 in FIG. 2, can send a number of requests 422, analogous to a number of requests 222 in FIG. 2. The number of requests can be evaluated 424.

A number of requests 422 can be created from a number of links 466, in a web page 434 that is created by a website. A number of links 466 can include a number of regular links and a number of invisible links 470. The invisible links 470 can be part of a trap path such that requests that are created when a user 420 selects an invisible link indicate progression in a trap path.

A number of life points can be adjusted 426 based on determining if a user is progressing on a safe path and/or a trap path. For example, a user 420 can lose a number of points if it is determined that a request from the number of requests 422 was generated from an invisible link 470 from the number of invisible links 470. A user 420 can be classified 428 based on a number of life points assigned to the user 420. A user 420 can be sanctioned 430 if the user is classified as unauthorized. A response 432 can be sent to a user 420 if a user is classified 428 as authorized.

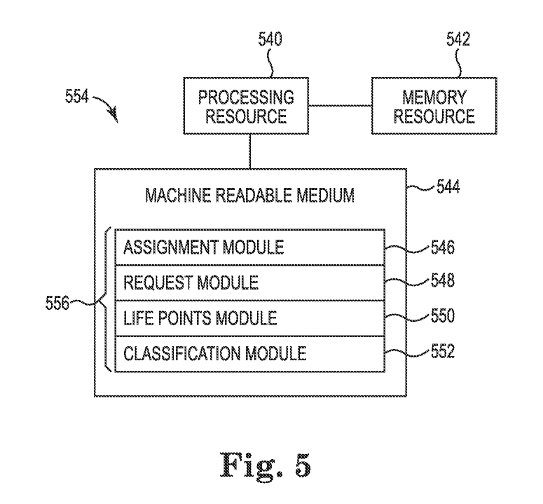

FIG. 5 illustrates an example computing device according to the present disclosure. The computing device 554 can utilize software, hardware, firmware, and/or logic to perform a number of functions.

The computing device 554 can be a combination of hardware and program instructions configured to perform a number of functions. The hardware, for example, can include one or more processing resources 540, machine readable medium (MRM) 544, memory resource 542, etc. The program instructions, e.g., machine-readable instructions (MRI) 556, can include instructions stored on the MRM 544 to implement, a desired function, e.g., unauthorized user classification.

The processing resources 540 can be in communication with the tangible non-transitory MRM 544 storing the set of MRI 556 executable by one or more of the processing resources 540, as described herein. The MR1 556 can also be stored in remote memory managed by a server and represent an installation package that can be downloaded, installed and executed. The computing device 554 can include memory resources 542, and the processing resource 540 can be coupled to the memory resource 542.

Processing resource 540 can execute MRI 556 that can be stored on internal or external non-transitory MRM 544. The processing resource 540 can execute MRI 556 to perform various functions, including the functions described with respect to FIG. 1, FIG. 2, FIG. 3, and FIG. 4, among others.

The number of modules 546, 548, 550, and 552 can include MRI 556 that when executed by the processing resource 540 can perform a number of functions. The number of modules 546, 548, 550, and 552 can be sub-modules of other modules. For example, the assignment module 546 and the request module 548 can be sub-modules and/or contained within a single module. Furthermore, the number of modules 546, 548, 550, and 552 can comprise individual modules separate and distinct from one another.

An assignment module 546 can comprise MRI 556 and can be executed by the processing resource 540 to assign a number of life points to a user. A number of life points assigned to a user can be in relation to a number of point thresholds. For example, a number of life points assigned to a user can be smaller than a first point threshold and larger than a second point threshold. A number of life points assigned to a user can be in relation to a number of points that can be lost and/or gained when a user follows a trap path and/or a safe path, respectively. For example, a number of life points assigned to a user can be 10 if 2 points can be lost and/or gained for following a trap and/or a safe path, respectively, or the number of life points assigned to the user can be 100 if 20 points can be lost and/or gained for following the trap and/or the safe path. However, examples are not so limited.

A request module 548 can comprise MRI 556 and can be executed by the processing resource 540 to receive a number of requests from a user. A number of requests can be associated with a number of links. For example, a number of requests can be created when a user selects a number of links. A number of requests can request access to data and/or other resources that a website can offer.

A life points module 550 can comprise MRI 556 and can be executed by the processing resource 540 to adjust a number of life points based on a relationship between the number of requests. The number of requests can be related in a number of ways. For example, a number of requests can be related because they are part of a trap path and/or a safe path. In sonic examples, a number of requests can include requests that are not related. Requests that are not related can indicate that a user is neither on a safe path nor a trap path. A number of requests can be associated with a number of links in a website. A number of relationships between a number of links in a website can define a number of corresponding relationships between a number of requests that are associated with the number of links in the website.

Adjusting a number of life points can include removing points from the life points assigned to a user and/or adding points to the life points assigned to the user. In a number of examples of the present disclosure, a user can follow a number of paths at the same time. For example, a request can be associated with a link that is part of a safe path and a trap path. A website can request that a user provide a password, e.g., secret token. A secret token can be part of a first safe path that leads to a first level, e.g., access to a first dataset from a website and a second level, e.g., access to a second dataset from the website.

A classification module 552 can comprise MRI 556 and can be executed by the processing resource 540 to classify a user as unauthorized when the number of life points fall below a point threshold. A user can be classified as authorized when then number of life points assigned to a user are greater than a point threshold. As used herein, a classification can include a authorized, unauthorized, and/or other variations that can assigned different rights, privileges, and/or sanctions to the different classifications.

A non-transitory MRM 544, as used herein, can include volatile and/or non-volatile memory. Volatile memory can include memory that depends upon power to store information, such as various types of dynamic random acces memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory MRM 544 can be integral or communicatively coupled to a computing device in a wired and/or wireless manner. For example, the non-transitory MRM 544 can be an internal memory, a portable memory, and a portable disk, or a memory associated with another computing resource, e.g., enabling MRIs 556 to be transferred and/or executed across a network such as the Internet.

The MRM 544 can be in communication with the processing resource 540 via a communication path. The communication path can be local or remote to a machine, e.g., a computer, associated with the processing resource 540. Examples of a local communication path can include an electronic bus internal to a machine, e.g., a computer, where the MRM 544 is one of volatile, non-volatile, fixed, and/or removable storage medium in communication with the processing resource 540 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path can be such that the MRM 544 is remote from a processing resource, e.g., processing resource 540, such as in a network connection between the MRM 544 and the processing resource, e.g., processing resource 540. That is, the communication path can be a network connection. Examples of such a network connection can include local area network (LAN), wide area network (WAN), personal area network (PAN), and the Internet, among others. In such examples, the MRM 544 can be associated with a first computing device and the processing resource 540 can be associated with a second computing device, e.g., a Java® server. For example, a processing resource 540 can be in communication with a MRM 544, wherein the MRM 544 includes a set of instructions and wherein the processing resource 540 is designed to carry out the set of instructions.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations. What is claimed:

1. A method for unauthorized user classification comprising:
assigning a user a number of life points, wherein the user is identified through an associated internet protocol (IP) address and associated browser header information;
receiving a first request for a first set of data and a second request for a second set of data from the user;
adjusting the number of life points based on a relationship between the first request and the second request, wherein the relationship is a pattern including the first request and the second request that is used to determine whether the user is an automated user; and
classifying the user as unauthorized when the number of life points fall below a point threshold.

2. The method of claim 1 wherein adjusting the number of life points based on the relationship between the first request and the second request includes:
determining a time interval between the first request and the second request;
removing life points from the user if the determined time interval is smaller han a time interval threshold; and
granting life points to the user if the determined time interval is greater than the time interval threshold.

3. The method of claim 2, wherein the time interval threshold is an average time interval between a number of consecutive requests wherein the number of consecutive request are a set of historic data.

4. The method of claim 1, wherein adjusting the number of life points based on the relationship between the first request and the second request includes:
determining if the first request and the second request are a product of selecting a first link in a web page and a second link in the web page; and
removing life points from the user if it is determined that the first request and the second request appea consecutive order within the first web page.

5. The method of claim 1, wherein adjusting the number of life points based on the relationship between the first request and the second request includes removing life points from the user if it is determined that either of the first request or the second request is a product of selecting an invisible link.

6. A non-transitory machine-readable medium storing instructions for unauthorized user classification executable by a computer to cause the computer to:
assign a user a number of life points;
receive an Hypertext Transfer Protoco (HTTP) request from the user;
determine whether the HTTP request exhibits good behavior or had behavior;
remove life points from the user for bad behavior and add life points to the user for good behavior; and
classify the user as unauthorized when the number of life points fall below a point threshold.

7. The medium of claim 6, wherein the instructions to determine whether the HTTP request exhibits good behavior or bad behavior include defining good behavior as behavior indicative of a human user and defining bad behavior as behavior indicative of an automated user.

8. The medium of claim , wherein the instructions are further executable to:
provide a trap path in a level wherein the trap path defines bad behavior and wherein the level defines an access that the user has to a set of data, the trap path including a first number of links within a web page;
provide a safe path in the level wherein the safe path defines good behavior, the safe path including a second number of links within the web page: and
wherein the trap path and the safe path define whether the HTTP request exhibits good behavior or bad behavior depending on whether the HTTP request was generated from one of the links in the first number of links or one of the links in the second number of links.

9. The medium of claim 8, therein the instructions are further executable to:
add his points to the user for good behavior include adding life points to the user when the HTTP request was generated from a link in the safe path; and
remove life points from the user for bad behavior include removing life points from the user when the HTTP request was generated from a link in the trap path.

10. The medium of claim 8, wherein the instructions are further executable to:
determine a first progression of the HTTP request on the trap path according to a placement of a link that generated the HTTP request in the trap path; and
determine a second progression of the HTTP request on the safe path according a placement of the link that generated the HTTP request in the safe path.

11. The medium of claim 10, wherein the instructions executable to remove life points from the user for bad behavior and add life points to the user for good behavior include instructions to:
remove life points from the user based on the first progression of the HTTP request on the trap path, wherein the closer the first progression is to an end of the trap path the greater a number of life points that are removed from the user; and
add life points to the user based on the second progression of the HTTP request on the safe path, wherein the closer the second progression is to an end of the safe path the greater a number of life points that are added to the user.

12. The medium of claim 10, wherein the instructions are further executable to:
move the user from the level to a lower level when the HTTP request was generated from an end trap link in the trap path;
wherein the lower level restricts the access that the user has to the set of data compared to the access that the user has to the set of data in the level; and
wherein the end trap link is a last link in the trap path that identifies an end of the trap path.

13. The medium of claim 10, wherein the instructions are further executable to:
move the user from the level to a higher level when the HTTP request was generated from an end trap link in the safe path;
wherein the higher level grants the user greater access to the set of data compared to the, access that the user has to the set of data in the level, and
wherein the end sate link is a last link in the safe path that identifies an end of the safe path.

14. A system for unauthorized user classification, comprising:
a processing resource in communication with a machine-readable medium, wherein the computer readable medium includes a set of instructions, and wherein the processing resource is designed to execute the set of instructions to
include a first number of links in a first web page and a second web page, wherein the first number of links define a safe path;
include a second number of links in the first web page and the second web page, wherein the second number of links define a trap path;
assign a user a number of life points that is greater than a first point threshold;
receive an Hypertext Transfer Protocol (HTTP) request from the user that is created by selecting a first link;
determine if the HTTP request is associated with the first number of links in the safe path or the second number of links in the trap path;
add life points to the user based on determination that the HTTP request is associated with the safe path or remove life points from the user based on a determination that the HTTP request is associated with the trap path; and
classify the user as unauthorized when the number of life points fall below the first point threshold.

15. The system of claim 14, wherein:
classifying the user as unauthorized includes sanctioning the user until the life points rise above a threshold;
wherein a first sanction included delaying a response to the HTTP request proportional to the deviation of the number of life points from the first point threshold;
wherein a second section includes ignoring the HTTP request if the number of life points falls bellow a second point threshold.
